(19) United States
(12) Patent Application Publication
(10) Pub. No.: US 2009/0288918 A1
(43) Pub. Date: Nov. 26, 2009

(54) Column Lifting Platform for Motor Vehicles

(75) Inventor: Winfried Schmitt, Bichl (DE)

Correspondence Address: OLIFF & BERRIDGE, PLC, P.O. BOX 320850, ALEXANDRIA, VA, 22320-4850, US

(73) Assignee: MAHA MASCHINENBAU HALDENWANG GMBH & CO. KG, Haldenwang (DE)

(21) Appl. No.: 12/308,227

(22) PCT Filed: Feb. 1, 2007
(86) PCT No.: PCT/DE2007/000181

§ 371 Date: Dec. 10, 2008

(30) Foreign Application Priority Data
Sep. 12, 2006 (DE) 20 2006 013 961.3

(51) Int. Cl. B66F 7/28

(52) U.S. Cl. 187/216

(57) ABSTRACT

The invention relates to a lifting platform, in particular a column lifting platform, for motor vehicles, having at least one column which is fixedly anchored on the ground, having a lifting carriage which is guided in a vertically movable fashion on the respective column, having at least one longitudinally adjustable load-bearing arm which is articulatedly fastened to the lifting carriage and which has end-side supports, having a drive unit which is mounted at the top end of the respective column and having a gear train which is kinematically coupled to the drive unit and to the lifting carriage, characterized in that a guide rail which is aligned axially parallel to a load bearing spindle is fastened to the column, a rail head of which guide rail is engaged around with a sliding fit by a guide element.

The invention relates to a column lifting platform for motor vehicles, having at least one column which is fixedly anchored on the ground, having a lifting carriage which is guided in a vertically movable fashion on the respective column, having at least one longitudinally adjustable load-bearing arm which is articulatedly fastened to the lifting carriage, can be swivelled in the horizontal plane and has end-side supports for the motor vehicle, and having a drive unit which is mounted at the top end of the respective column and kinematically coupled to the lifting carriage via a gear train.

Column lifting platforms of this kind are known in various embodiments. One of the technical advantages lies in the fact that no construction works in the foundation are necessary to install them, as is required in the case of so-called lifting plunger platforms. Conventionally, use is made of such lifting platforms comprising two columns, with two telescopic load-bearing arms being provided on each column. At their free end, the load-bearing arms have a support in the form of an adjustable outrigger which is positioned by extending and swivelling the respective load-bearing arm below a predetermined suitable ground site of the vehicle to be lifted. When the vehicle is lifted and lowered, considerable load is exerted on the more or less extended load-bearing arms, which loads are fed as moments of tilt into the lifting carriage and the corresponding bearing elements of the column. Sliding pads, rollers or the like guide elements sliding or rolling on corresponding surfaces of the column are used to guide the lifting carriage in its vertical movements. In this process, a load focussed on small regions is always generated which, if frequently repeated, may be the cause for damage to the column and/or the guide elements.

It is the object of the invention to provide a column lifting platform, particularly for motor vehicles, which enables a more favorable distribution of the forces and loads affecting the lifting carriage to the column.

This object is achieved by the features stated in claim 1.

According to the invention, the aspiredly exact guide highly capable of bearing of the lifting carriage on the column is achieved by a linear guide formed by a dimensionally stable guide rail fastened to the column and a guide element engaging around the rail head with a sliding fit.

Suitably, the guide rail has a broadened stand with which it is permanently fixed to a side wall of the column. The rail head, which may have a cylindrical or rounded-edged cross-section, is fixedly connected to the stand.

According to a suitable embodiment of the invention, the effective length of the guide element approximately corresponds to the height of the lifting carriage formed in a manner known per se.

In order to reduce the friction resistance in the vertical movements of the lifting carriage, the guide element has a slideway lining with which it closely fits to the rail head. The guide element may be formed as a continuous pipe or consist of several sliding bushes suitably disposed at the top and bottom ends of the guide element.

The guide element can be formed such that no or only very slight torsional forces are transmitted to the entire column if there is a load pickup. Thus, the column can be prevented from being distorted by the load pickup.

Below, an embodiment of the invention will be described in detail with reference to the drawings, wherein:

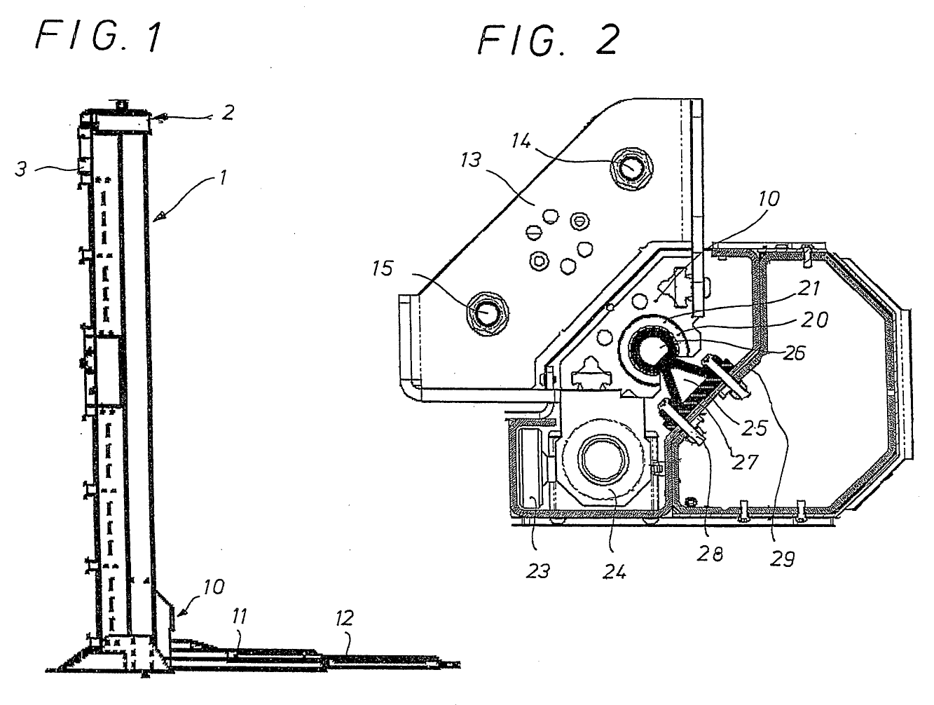

FIG. 1 shows a schematic side view of the column of a column lifting platform,

FIG. 2 shows a schematic plan view in a partial cross-section of the guide system according to the invention,

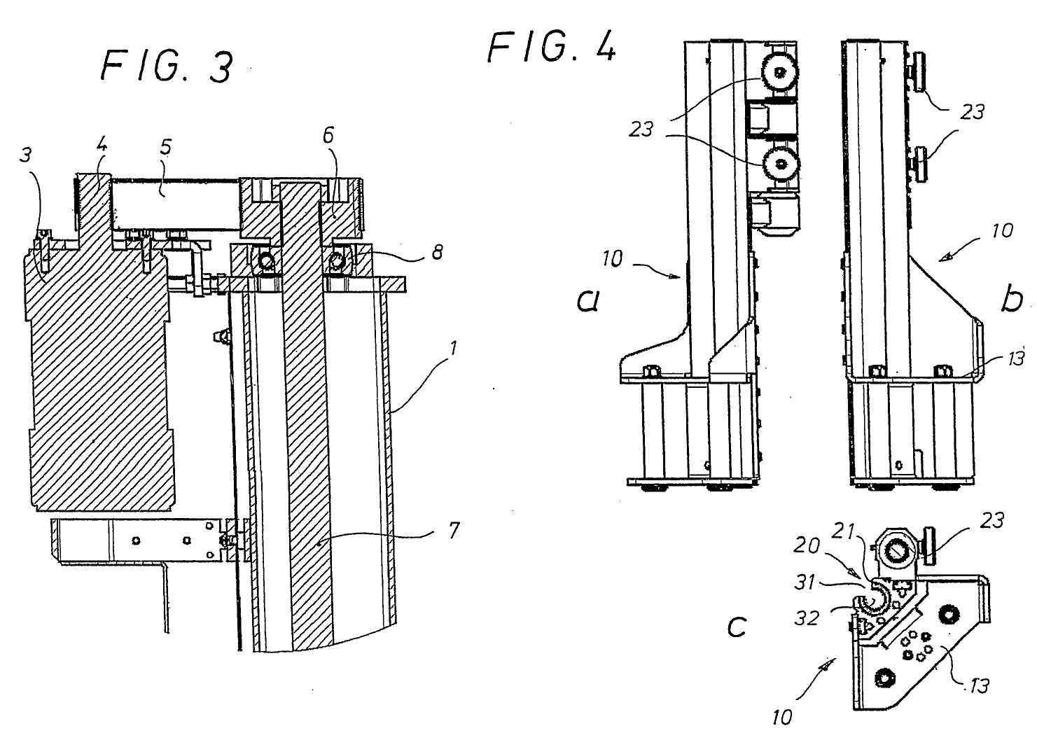

FIG. 3 shows a schematic longitudinal section of the top end part of the column with the drive motor,

FIG. 4 shows a schematic side view and a plan view of the lifting carriage.

The column shown in FIG. 1 belongs to a 2-column lifting platform. Column 1 consists of a hollow profile made of sufficiently thick steel plate or hot rolled strip, respectively. A drive unit 2 is located in the top part of column 1, which is shown in detail in FIG. 3 and comprises an electric motor 3 disposed axially parallel. The vertically aligned shaft 4 of the electric motor 3 is kinematically coupled to a pulley 6 via a driving belt 5 of sufficient tensional strength, for example, a toothed belt. This pulley 6 has a larger diameter in contrast to the pulley positioned on the motor shaft 4, whereby a suitable gearing down is achieved. The pulley 6 is located in a torsionally strong manner on a load-bearing spindle 7 supported in a bearing pulley 9 fastened to the top end of the column 1 via a cup and ball bearing 8 which is axially loadable. The lifting carriage 10 shown in several views in FIG. 4 is disposed on this rotationally driven load-bearing spindle 7 by means of a nut in a manner known per se. By rotating the load-bearing spindle 7 by means of the electric motor 3, the lifting carriage 10 performs vertical lifting and lowering movements.

As can be taken from FIG. 1, two horizontal load-bearing arms 11, 12 are fastened to the lifting carriage 10 in an articulated way which are formed like telescopes and respectively have a load-bearing element at their free end. Horizontal bearing plates 13 having supporting bearings 14, 15 for the load-bearing arms 11, 12 are fastened to the lifting carriage.

As can be taken from FIGS. 2 and 4c, the lifting carriage 10 comprises a partially circular recess 20 open at one side in a corner, which recess 20 is lined with a slideway lining 21. Together with the slideway lining 21, this recess 20 forms a guide element for the lifting carriage 10 and for the load-bearing arms 11, 12 fastened therein.

Furthermore, as a rotary protection and in order to stabilize the guide, the lifting carriage comprises rollers 23, 24 shifted by 90° and running on corresponding inner sides of column elements.

The stable guide of the lifting carriage 10 on the column is realized by means of a dimensionally stable, profiled guide rail 25 which in the embodiment as shown comprises a partially cylindrical rail head 26 as well as a broadened rail stand 27 integrally connected thereto. This rail stand 27 is permanently fastened to the diagonal middle part 29 of the column wall by means of bolts.

The guide rail 25 is aligned axially parallel to the load-bearing spindle 7 and disposed such that its protruding rail head 26 is engaged around with a sliding fit by the substantially pipe-like guide element 20. In the embodiment as shown, the rail head 26 formed as one piece with the broadened rail stand 27 is partially cylindrically formed and engaged around by the guide element 20 having a circular cavity 32 interrupted by a longitudinal slot 31. The effective length of the guide element 20 approximately corresponds to the height of the lifting carriage 10 whereby a high load-bearing capability of the overall guide arrangement is achieved. The slideway lining 21 of the guide element 20 may be continuous across the entire length of the guide element or may consist of several parts fixed in the guide element 20 in the form of sliding bushes.

1. A lifting platform for motor vehicles, having
at least one column which is fixedly anchored on the ground,
a lifting carriage which is guided in a vertically movable fashion on the respective column,
at least one longitudinally adjustable load-bearing arm which is articulatedly fastened to the lifting carriage and which has end-side supports,
a drive unit which is mounted at the top end of the respective column, and
a gear train which is kinematically coupled to the drive unit and to the lifting carriage, wherein
a guide rail which is aligned axially parallel to a load bearing spindle is fastened to the column, a rail head of which guide rail is engaged around with a sliding fit by a guide element.

2. The lifting platform according to claim 1, therein
the rail head is partially cylindrical and the guide element has a circular cavity interrupted by a longitudinal slot.

3. The lifting platform according to claim 1, wherein
the effective length of the guide element corresponds to approximately the height of the lifting carriage.

4. The lifting platform according to claim 1, wherein
the guiding element has a slideway lining.

5. The lifting platform according to claim 1, wherein
the guide element contains a plurality of slide bushes.

6. The lifting platform according to claim 1, wherein
the guide rail profiled in cross-section is permanently fastened to a side wall of the column with a broadened stand.

7. The lifting platform according to claim 1, wherein
the head of the guide rail has a circular, elliptical or rounded-edged cross-section, the inner shape of the guide element being adapted to this head cross-section.

8. The lifting platform according to claim 1, wherein
the slideway lining is continuous across the entire length of the guide element or formed of a plurality of parts, the slideway lining or the parts in the form of sliding bushes being fixable in the guide element.

9. The lifting platform according to claim 1, wherein
the guide element is formed such that no or only very few torsional forces are transmitted to the column which prevents the column from being distorted by the load pickup.
